(19) United States
(12) Patent Application Publication
(10) Pub. No.: US 2016/0123542 A1
(43) Pub. Date: May 5, 2016

(54) Lighting Device

(71) Applicant: SEIDEL GMBH & CO. KG, Marburg (DE)

(72) Inventors: Andreas RITZENHOFF, Marburg (DE); Lutz ENGEL, Wilnsdorf (DE); Joerg RACHE, Marburg-Michelbach (DE); Oliver ARNOLD, Dautphetal-Allendorf (DE)

(21) Appl. No.: 14/891,618

(22) PCT Filed: May 13, 2014
(86) PCT No.: PCT/EP2014/059793

§ 371 Date: Nov. 16, 2015

(30) Foreign Application Priority Data
May 15, 2013 (DE) 10 2013 105 011.5
Feb. 5, 2014 (DE) 10 2014 101 403.0

(51) Int. Cl. F21K 99/00; F21V 29/89; F21V 29/70; F21V 15/01

(52) U.S. Cl. CPC F21K 9/135; F21V 15/01; F21V 29/89; F21V 29/70

(57) ABSTRACT

A lighting device includes at least one semiconductor illuminant and a plastic housing in which the at least one semiconductor illuminant is accommodated. The lighting device is has, inside the housing, a metallic base body on which the semiconductor illuminant is fixed. The metallic base body has a surface which is in contact, at least in sections, in the inside, with the housing.

### BACKGROUND AND SUMMARY OF THE INVENTION

The invention relates to a lighting device having at least one semiconductor illuminant and a housing made of plastic, in which the semiconductor illuminant is accommodated.

Lighting devices having semiconductor illuminants are distinguished by a high specific luminosity and therefore low power consumption and also by a long service life. The semiconductor illuminants have to be cooled in operation, since both the service life and also the achieved effectiveness decrease with the temperature of the illuminant. The demand for effective cooling of the semiconductor illuminant also increases with the increasingly rising light power of the semiconductor illuminant and therefore also the increasing electrical power consumption. In addition to cooling bodies and semiconductor illuminants, a driver component for the semiconductor illuminant, also called a connection module, is frequently arranged in the housing of the lighting device, which provides a current suitable for activating the semiconductor illuminant. Furthermore, an optical element, for example, a reflector and/or a lens arrangement, is optionally provided to achieve a desired spatial emission characteristic.

In particular in the case of so-called retrofit lighting devices, which are adapted in the shape thereof and with regard to the electrical connection to known embodiments of lighting devices, for example, incandescent bulbs or fluorescent tubes, the lighting device and accordingly the housing must meet narrow guidelines with respect to the shape and the appearance. In previously known semiconductor lighting devices, this could only be achieved using a relatively complex structure, which could be assembled with mechanical effort. The production process of such known lighting devices has proven to be correspondingly complex, which is reflected in the price, on the one hand, and also in inadequate quality, on the other hand.

To be able to dissipate the heat arising inside the housing of the semiconductor lighting device, at least portions of the housing are frequently produced from metal, for example, aluminum. These housing portions, which act as cooling bodies, are optionally additionally equipped with cooling ribs, so that heat can be effectively dissipated via convection. The use of such an external metal portion of the housing is complex to manufacture, however, and accordingly costly. In addition, the portion acting as cooling bodies sets narrow limits on the design of the lighting device.

It is therefore one object of the present invention to provide a lighting device of the type mentioned at the outset, in which effective heat dissipation is achieved even without metallic housing portions, which act as cooling bodies. The lighting device is additionally to be producible cost-effectively and with uniform quality.

This object is achieved by a lighting device according to exemplary embodiments of the present invention.

According to the invention, a lighting device of the type mentioned at the outset is distinguished in that the lighting device has, inside the housing, a metallic base body, on which the semiconductor illuminant is fixed, wherein the metallic base body has a surface, which rests at least in portions internally against the housing.

Heat dissipation which effectively contributes to the cooling can take place via the plastic housing due to the surface pressing internally against the housing, even with an internal metallic base body. The metallic base body is used as a carrier and simultaneously represents a cooling element for the semiconductor illuminant, so that good dissipation of the heat generated by the semiconductor illuminant in operation takes place. In this case, the surface of the base body preferably rests (presses) against an inner surface of a wall of the housing in a close fit, to enable the best possible heat transfer. The contact surface is preferably a large fraction of the overall surface of the base body, for example, at least 30%, preferably at least 50%. Furthermore, the base body is preferably essentially rotationally-symmetrical, like the housing, in the region of the contact surface. The contact surface is then preferably the whole or a part of the lateral surface of the base body.

In one preferred embodiment of the lighting device, the base body is fixed in a latching or clamping manner in the housing. The base body preferably has a catch bead, which latches under at least one catch projection arranged in the housing. Furthermore, the catch bead and an undercut part of the catch projection are preferably shaped so that the catch bead has movement clearance in a catch position.

In this manner, impermissible tensions in the materials as a result of different thermal expansions of the metallic base body and the plastic housing are prevented.

The movement clearance particularly preferably extends in the direction of a wall of the base body. For example, contact surfaces between the base body and the housing are avoided in the region of the latching, the surface perpendiculars of which are located in the direction of the thermal expansion of the base body. In the event of expansion of the base body in relation to the housing, the latched part of the housing can deviate in the latched position, without detaching the latching.

With regard to the production process and a space-saving structure, the base body is preferably embodied in two parts, wherein it is assembled from a lower shell and an upper shell, for example. The two shells form a cavity, in which a connection element for the power supply of the semiconductor illuminant is arranged.

In a further advantageous embodiment of the lighting device, the semiconductor illuminant is fixed using a rivet on the base body, for example, its upper shell. The rivet is preferably integrally formed with the base body, whereby the semiconductor illuminant can be fastened in a particularly simple and cost-effective manner on the base body as the carrier. The integral formation also enables the rivet to deform for the fastening, without having to press using a tool against the side opposite to the semiconductor illuminant. Deformation of the rivet can take place solely from the outer side of the base body. The base body, for example, again the upper shell, is particularly advantageously originally formed with the rivet in a deep-drawing method. The upper shell is then molded and the rivet is formed in only one production step. Upper shell and also lower shell can be deep-drawn from aluminum, for example.

In a further advantageous embodiment of the lighting device, the semiconductor illuminant can also be fixed by means of a screw on the base body, in particular on its upper shell.

The described lighting device can be designed particularly well as a retrofit lighting device, in which, for example, an appearance and a connection scheme of a classical incandescent bulb is simulated.

Exemplary embodiments of the lighting device according to the invention are explained in greater detail hereafter with the aid of figures. The exemplary embodiments illustrate further advantageous embodiments of the lighting device or of components of the lighting device. In the figures:

### BRIEF DESCRIPTION OF THE DRAWINGS

FIG. 1 is a first exemplary embodiment of a lighting device in the retrofit style in schematic exploded illustration;

FIG. 2 is a second exemplary embodiment of a lighting device in the retrofit style in schematic exploded illustration;

FIG. 3 is a third exemplary embodiment of a lighting device in the retrofit style in schematic exploded illustration;

FIG. 4 is a schematic illustration of a fastening of an illuminant on an upper shell of the base body;

FIGS. 5A-5C are cross-sectional views schematically illustrating a fastening of the illuminant on the upper shell of the base body of a lighting device;

FIGS. 6A and 6B are schematic illustrations of a fully assembled lighting device and a detailed region thereof, respectively;

FIGS. 7A and 7B are cross-sectional illustrations showing the housing lower part with an inserted lower shell and a detailed view thereof, respectively;

FIG. 7C is a perspective view of the housing upper part;

FIG. 8 is a side view of the connection module;

FIG. 9 is a top view of the connection module of FIG. 8;

FIG. 10 is a cross-sectional view illustrating an electrical connection between multiple printed circuit boards;

FIG. 11 is a sectional illustration of a dome, which is provided with passages in greatly varying geometry;

FIG. 12 is a cross-sectional view of an optical element for the lighting device according to an exemplary embodiment;

FIGS. 13 and 14 are cross-sectional views according to exemplary embodiments illustrating how an optical element of the lighting device can be fixed on the illuminant; and

FIG. 15 is a perspective illustration of a three-dimensionally formed illuminant.

### DETAILED DESCRIPTION OF THE DRAWINGS

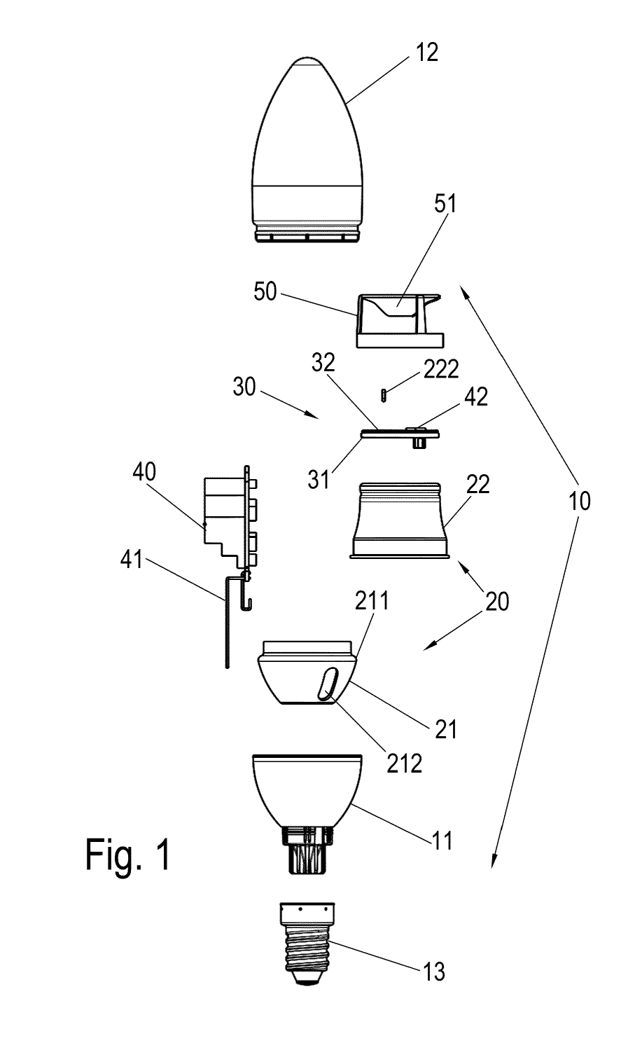

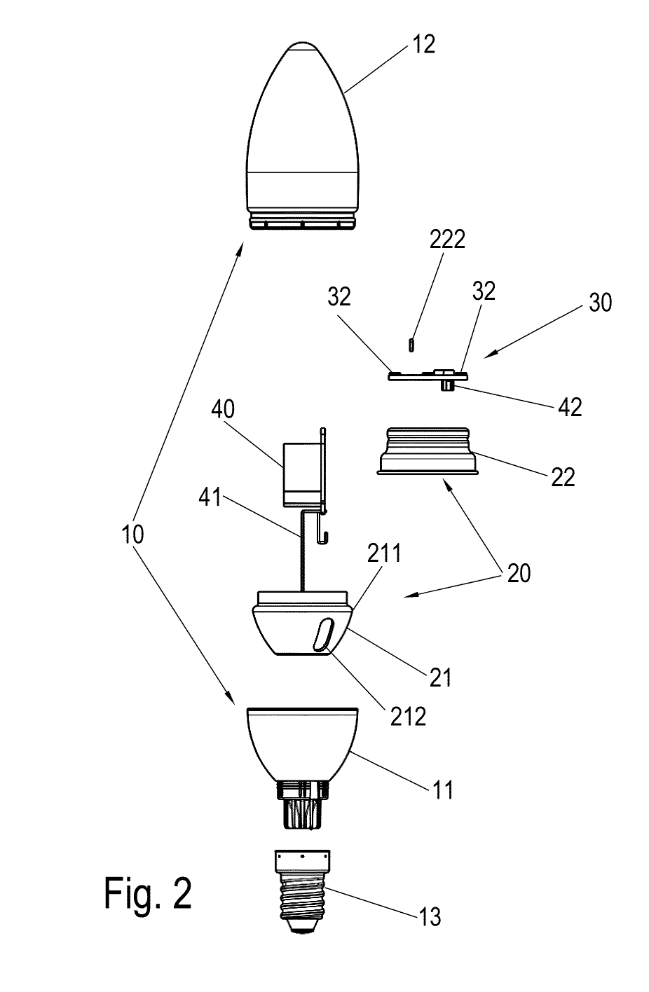

FIGS. 1 to 3 show three different exemplary embodiments of a lighting device according to the application, each in a perspective exploded illustration. Identical or identically acting elements are identified in these and the following figures by identical reference signs.

In all three illustrated exemplary embodiments, the lighting device is designed as a retrofit lighting device, i.e., it is oriented with regard to the electrical connection and also the shaping to known illuminants, incandescent bulbs having a screw thread here (E14 or E27). It is to be noted that the features shown in this application can also be implemented in lighting devices having different shaping and/or different connection sockets or connection capabilities, including lighting devices which are not designed as retrofit lights. The proposed features are partially also usable in other electronics applications, which do not have illuminants.

The lighting device has a housing 10, which has a housing lower part 11 and a housing upper part 12 placed thereon, and also a base 13, which is attached to the housing lower part 11 opposite to the housing upper part 12, and which is used for holding the lighting device in a socket and for the electrical contact. A latching or snap-in connection of the housing lower part 11 and the housing upper part 12 is provided. For this purpose, the parts in the connection region are accordingly designed as interlocking A catch is preferably provided, which can transmit a torque, so that the two housing parts 11, 12 can be fixed in a twist-locked manner with one another. Except for the contacting surfaces on the base 13, the individual parts of the housing 10 are manufactured from plastic, preferably in an injection molding method. At least the housing upper part 12 is kept translucent or transparent in this case, to dissipate the light emitted from the lighting device. The housing upper part 12 can advantageously be produced in an injection blowmolding method.

A base body 20 is inserted into the housing 10, which is constructed in two parts in each of the cases shown here and has a lower shell 21 and an upper shell 22 connected thereto. The base body 20 has manifold functions. It is used, for example, for holding a semiconductor illuminant 30, referred to as illuminant 30 hereafter, which is fastened on the upper shell 22.

Furthermore, the base body 20 is produced from a material having good thermal conductivity, preferably a metal such as aluminum, and is therefore used for heat dissipation of heat produced by the illuminant 30. Both the lower shell 21 and also the upper shell 22 are preferably produced in a deep-drawing method, which enables cost-effective manufacturing with the thinnest possible wall thicknesses. The lower shell 21 and the upper shell 22 are connected to one another in a mechanically loadable manner, whereby good heat conduction from the upper shell 22 to the lower shell 21 is also provided, so that the lower shell 21 can also absorb and relay or dissipate heat from the illuminant 30. Both elements, lower shell 21 and upper shell 22, are constructed as essentially rotationally-symmetrical, wherein the connection of the two elements to one another is produced by a joined fit, optionally supported by catch means in the connection region, for example, a circumferential bead or notch formed in the connection region.

When assembled, the base body 20 is essentially in the form of a capsule, wherein a connection module 40 is accommodated in its inner cavity. The connection module 40 is used to convert the alternating current of the home lighting network, i.e., for example, in the voltage range from 110 V to 230 V, which is supplied via the base 13 into a direct current which is suitable for supplying the illuminant 30.

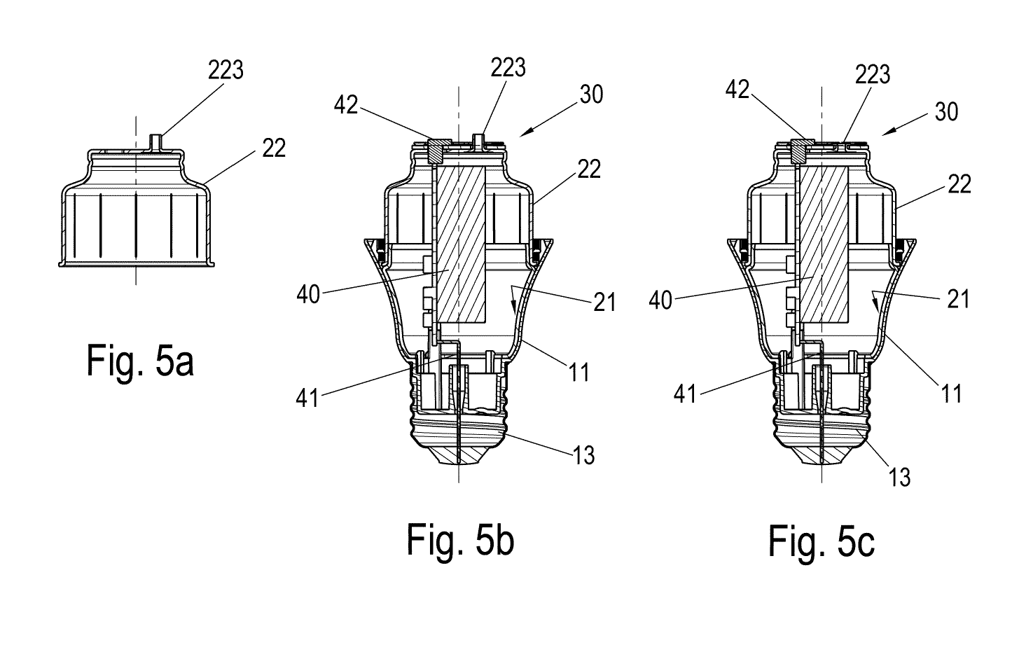

According to the invention, the base body 20 and the housing lower part 11 are latched with one another, wherein the latching is formed so that a thermal expansion of the base body 20, in particular the lower shell 21 of the base body 20, does not exert an impermissible load, which causes material destruction or fatigue, on the housing lower part 11. In this case, good thermal contact is provided between the lower shell 21 and the housing lower part 11, so that heat arising inside the lighting device is dissipated, inter alia, via the housing lower part 11. The latching of the base body 20 with the housing lower part 11 is shown in greater detail in conjunction with FIGS. 5 to 7. Furthermore, an opening is provided at the bottom, in the direction of the base 13, in the lower shell 21, through which the connection wires 41 of the connection module 40 are led to the base 13. A passage is also introduced into the upper shell 22, through which an electrical connection is produced from the illuminant 30 to the connection module 40. This connection can be produced, for example, via a plug 42, which is previously installed, for example, soldered, onto the semiconductor illuminant 30.

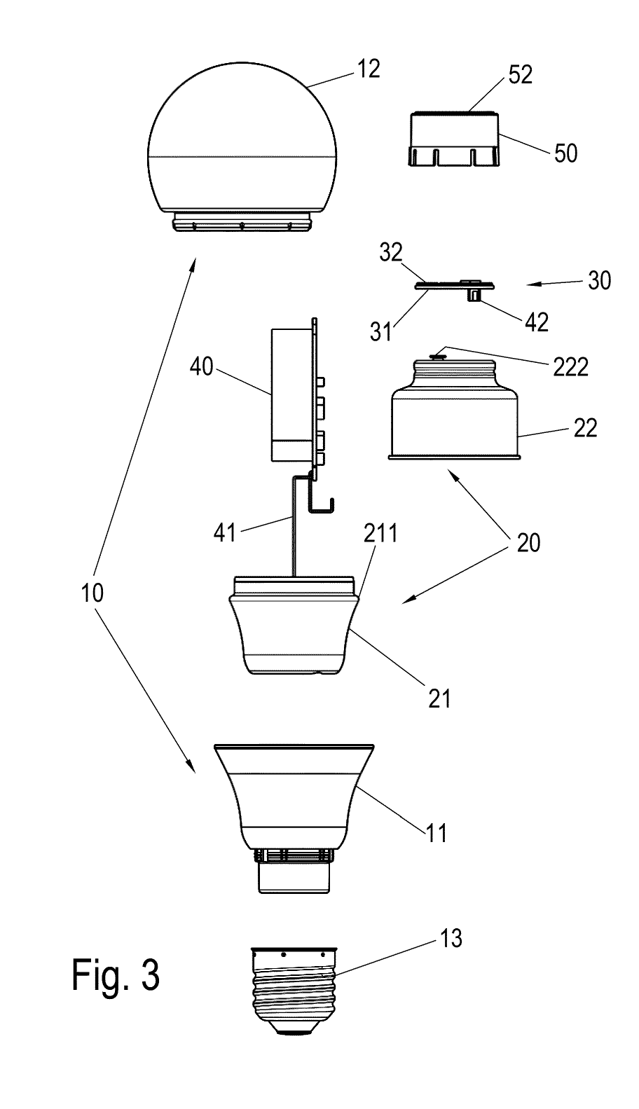

As the exemplary embodiments of FIGS. 1 to 3 show, the illuminant 30 can have a planar printed circuit board 31, on which a plurality of lighting elements, light-emitting diodes 32 (LEDs) here, are arranged. An illuminant 30 embodied in this manner emits essentially perpendicularly to the surface of the printed circuit board 31, i.e., in the direction of the axis of symmetry (screwing-in axis) of the lighting device. To also achieve emission perpendicularly to the axis of symmetry, in the exemplary embodiments of FIGS. 1 and 3, an optical element 50 is provided, which is arranged behind the illuminant 30 viewed in the emission direction and influences the emission characteristic of the lighting device. In the exemplary embodiments shown, the optical element 50 is mounted on the upper shell 22.

The optical element 50 is preferably also a metal element produced in the deep-drawing method, which can also absorb and dissipate heat because of the fastening on the upper shell 22 or directly on the printed circuit board 31. Alternatively, the optical element 50 can also be produced from plastic, wherein transparent and/or reflective components can be used.

In the exemplary embodiment of FIG. 1, the optical element 50 has reflective surfaces 51, which are embodied as rotationally-symmetrical in the form of a funnel. The reflective surfaces 51 deflect a majority of the radiation emitted from the light-emitting diodes 32 radially outward. The optical element 50 is centrally open, so that a further part of the radiation exits axially. In the exemplary embodiment of FIG. 3, the optical element 50 comprises a lens 52, which is arranged axially in front of the light-emitting diodes 32. The lens 52 is a divergent lens here, which widens the radiation bundle emitted from the light-emitting diodes 32 and thus broadens the emission characteristic in the radial direction. Because of its flat structural form, the lens 52 can advantageously be designed as a Fresnel lens. Optical elements 50 can also be used, which have both reflective surfaces 51 and also lenses 52.

The components of the lighting device are designed with regard to possible automation capability of the production process, in particular the process of assembling the lighting device. This includes, for example, parts being able to be easily grasped and oriented. Furthermore, connections between the parts are preferably snap and/or catch and/or joined connections, which can particularly preferably be assembled in a shared joining or latching direction, particularly preferably along the axis of symmetry of the lighting device, which, in the illustrated bases 13, is also the direction in which the lighting device is screwed into a socket. This direction is also referred to as the axial direction in the scope of the application.

The three lighting devices shown in FIGS. 1 to 3 differ in the precise shaping of the components thereof, the external dimensions, and the light power. Nonetheless, they all have a comparable basic structure. This enables a plurality of different lighting devices to be produced automatically on the same manufacturing lines, without profound changes being required on the manufacturing line or in the manufacturing process in the event of a model change. A type of building block system of design solutions is thus provided, using which it is possible to react rapidly to market demands and small changes in the components, for example, new illuminants. New developments can be integrated flexibly and rapidly into new products.

Further details of the lighting devices, which are relevant, inter alia, for manufacturing which can be automated, are described in the following advantageous embodiments of the lighting device.

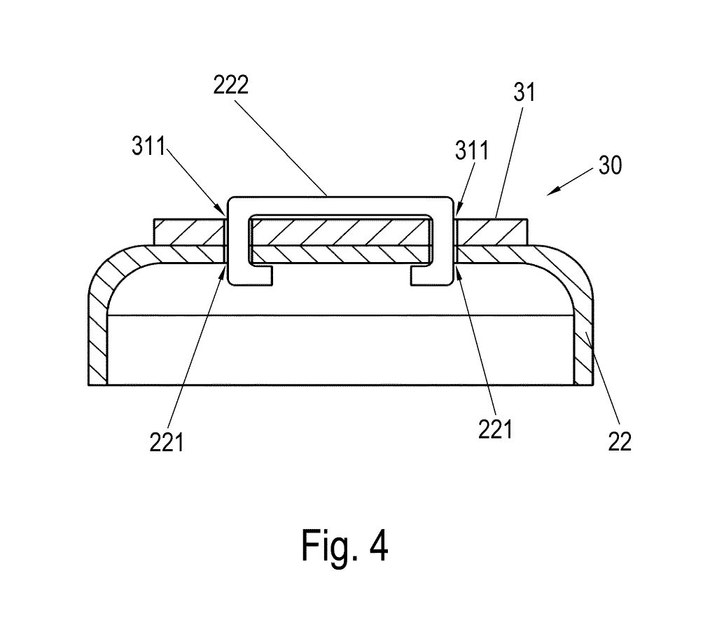

In FIGS. 1 to 3, an advantageous fastening possibility for the illuminant 30 on the upper shell 22 is indicated, which is shown in greater detail in FIG. 4. An adhesive connection or a screw connection has previously been used for the fastening of the illuminant 30. According to the application, it is provided that the illuminant 30 is fixed by means of a form fit with the aid of a deformable connecting element on the upper shell 22.

In the examples of FIGS. 1 to 4, a fastening clamp 222 is used as the deformable connecting element, which is preferably plugged through previously introduced passages 311, 221 into the printed circuit board 31 of the illuminant 30 or the upper shell 22 and is bent over on the lower side by corresponding tools. The form of the bending over and the selected material enable in this case secure and elastic fixing, which is friction locked even in the event of thermal expansion, of the illuminant 30 on the upper shell 22, whereby a good thermal connection of the illuminant 30 to the base body 20 is provided. In addition, the fastening clamp 222, which preferably consists of a metal, for example, of a copper alloy, can be used for the electrical contacting of the illuminant 30. In addition, a heat conductive paste can be applied between the illuminant 30 and the upper shell 22.

A further exemplary embodiment of a lighting device is shown in FIGS. 5 to 7 in various illustrations and various assembly states. The fastening possibility indicated therein for the illuminant 30 on the upper shell 22 can also be used for the lighting devices of FIGS. 1 to 3.

Firstly, the upper shell 22 used is shown in FIG. 5a. The upper shell 22 has an integrally formed rivet 223 on its upper side, on which the illuminant 30 is installed. The rivet 223 represents an alternative to the fastening clamp 222 shown in FIG. 4. The rivet 223 can be designed as a hollow rivet or as a solid material rivet. As previously mentioned, the upper shell 22 is preferably produced from aluminum in a deep-drawing method. In this case, the rivet 223 is particularly preferably already formed in this deep-drawing method. The rivet 223 is thus formed in the original forming method, using which the upper shell 22 is brought into its basic shape. In this manner, the rivet 223 is not only integrally formed with the upper shell 22, but rather also in one production step.

The installation of the illuminant 30 with the aid of the rivet 223 is shown in FIGS. 5b and 5c. The lighting device is already partially preassembled for the installation of the illuminant 30. Specifically, the housing lower part 11 is already placed on or inserted into the base 13, of the base body 20, the lower shell 21 is inserted into the housing lower part 11 and latched thereto. For this purpose, a catch bead 211 is circumferentially formed on the housing lower part 11, which catches under catch projections (not provided with reference signs in FIG. 5) of the housing lower part 11. In addition, the connection module 40 is inserted into the lower shell 21, wherein the connection wires 41 are optionally already connected to the base 13, for example, soldered or plugged into corresponding plug contacts.

After placement of the upper shell 22 on the lower shell 21, the illuminant 30 is laid on the upper side of the upper shell 22, wherein the rivet 223 penetrates through the passage 311 provided for it of the printed circuit board 31 (not provided with reference signs in FIG. 5). The illuminant 30 is fixed on the upper shell 22, on the one hand, and contacted with the connection module 40, on the other hand, by means of the plug 42 through further passages (also not provided with reference signs) in the printed circuit board 31.

In a next processing step, the rivet 223 is deformed from above by force action of a stamp, so that it fixes the printed circuit board 31 in a formfitting manner on the upper shell 22. The upper shell 22 preferably rests circumferentially on its lower edge on the lower shell 21, so that the forces acting on the upper shell 22 during the bending of the rivet 223 can be dissipated well and over a large area downward. The deformation of the rivet 223 can be performed in the preassembled state of the illuminant for this reason. As mentioned in conjunction with the fastening clamp 222, in addition, at least a unipolar electrical contact can be produced via the rivet 223.

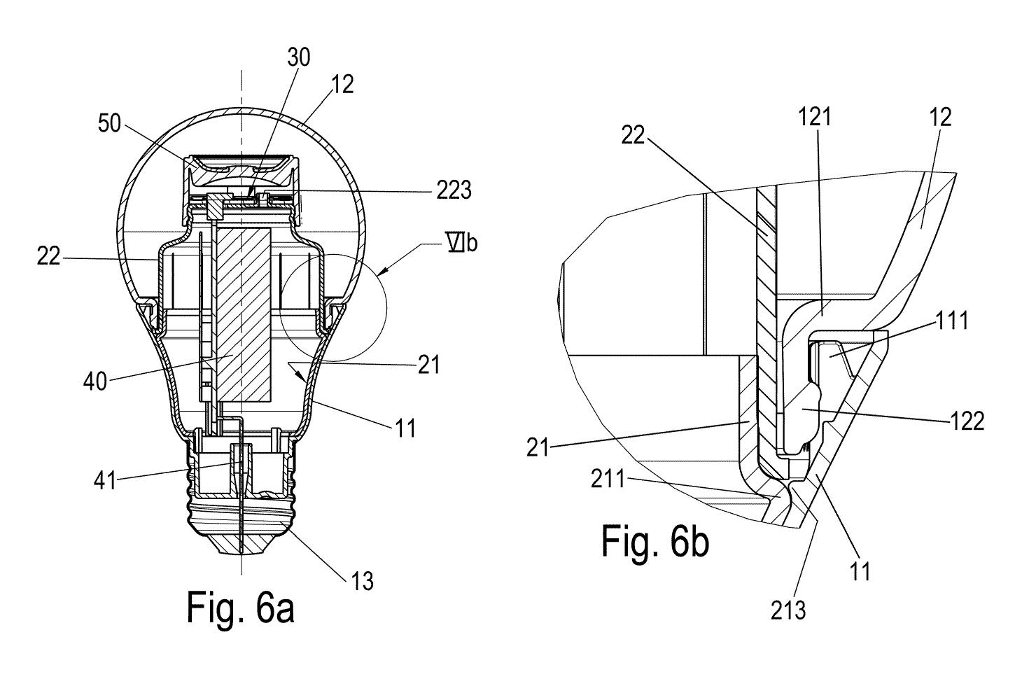

The further installation process is shown on the basis of FIGS. 6a and 6b. FIG. 6a firstly shows the fully assembled device. In relation to the state shown in FIG. 5c, the optical element 50 is put on, wherein this optical element 50 is designed so that it latches on the outer circumference thereof in the upper region of the upper shell 22. For this purpose, the upper shell 22 has a circumferential constriction in this region. Furthermore, the translucent housing upper part 12 is put on the housing lower part 11 and latched thereto.

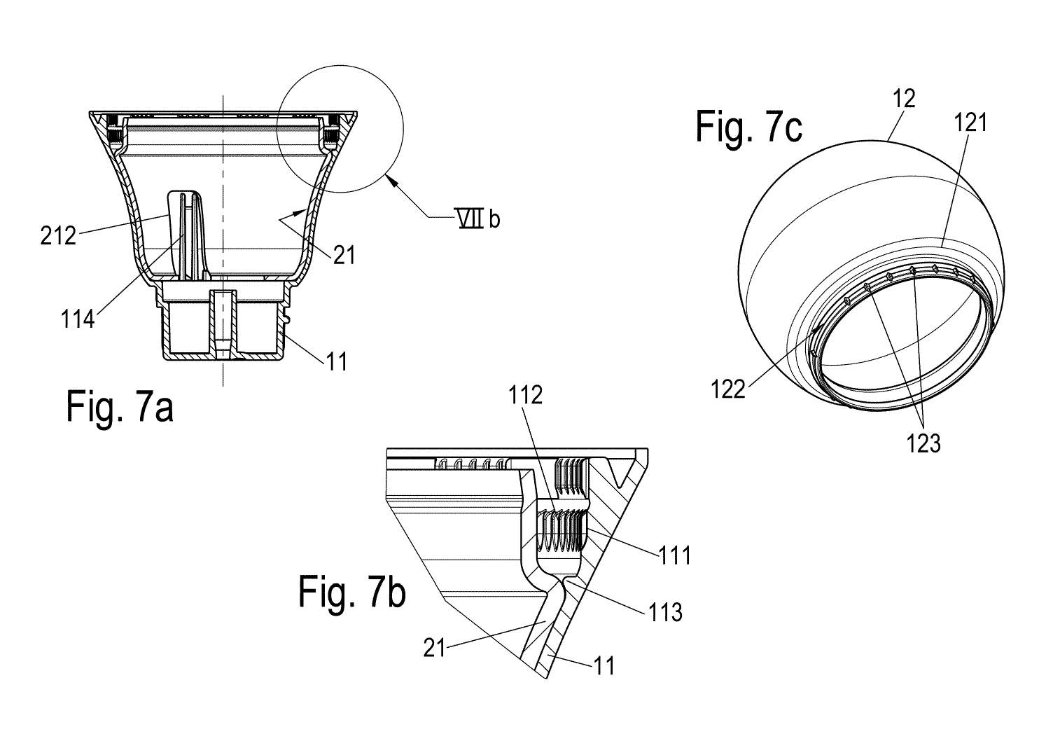

FIG. 6b shows the region, in which the lower shell 21 of the base body 20 and the housing upper part 12 are latched in the housing lower part 11, in greater detail. FIGS. 7a and 7b show additionally thereto the housing lower part 11 with inserted lower shell 21 separately in a sectional illustration, wherein in FIG. 7b, the latching region is again shown enlarged. FIG. 7c shows the housing upper part 12 separately in a perspective view.

As shown in particular in FIGS. 6b and 7b, for the latching of the housing upper part 12 with the housing lower part 11, a catch depression 111 is introduced in the upper region of the housing lower part 11, the upper edge of which forms an undercut catch projection pointing inward. The catch depression 111 can be formed circumferentially or at least partially circumferentially. In addition, a fluting 112 is incorporated in the catch depression 111.

A widened edge is formed on top by the catch projection on the housing lower part 11. The housing upper part 12 has a complementary bearing edge 121, with which it rests on the housing upper part 12. A tongue pointing downward is formed on the inner circumference on the bearing edge 121, also having a circumferential or at least partially circumferential catch lug 122 pointing outward. When the housing upper part 12 is plugged on, the catch lug 122 engages in an undercut of the catch projection 111. In the present case, the catch lug 122 is formed circumferentially and it is additionally provided with a plurality of ribs 123, which protrude once again. As can be seen in FIG. 7c, the ribs 123 are distributed along the circumference. When the catch lug 122 is engaged in the catch depression 111, the ribs 123 engage in the fluting 113, whereby the housing upper part 12 is connected in a rotationally-fixed manner with the housing lower part 11. This is important in particular in the case of a base 13 having a screw thread, to be able to screw and unscrew the lighting device conveniently. A rotationally-fixed connection also has to be provided in the case of lighting devices having a bayonet base.

In its lower region, the upper shell 22 is also angled slightly outward radially circumferentially. The tongue, on which the catch lugs 122 are formed, can be dimensioned so that the lower end thereof lies below this angling and therefore the upper shell 22 directly and indirectly also fixes the lower shell 21, on which the upper shell 22 rests circumferentially, in the housing lower part 11. Alternatively, a small distance can be provided between the tongue of the housing upper part 12 and the base body 20. In this case, the tongue of the housing upper part 12 does not directly fix the base body 20 in the housing lower part 11, but offers an additional safeguard for the case in which the actual fastening of the base body 20 detaches. Therefore, essentially all inner components of the lighting device are fixed or at least additionally secured in the lighting device by a catch connection between the housing upper part 12 and the housing lower part 11.

Details of the fastening of the lower shell 21 of the base body 20 with the housing lower part 11 are recognizable in FIGS. 6b and 7b. A catch projection 113 is formed on the inner side of the housing lower part 11 below the catch depression 111. It can be circumferential, or can consist of multiple distributed segments. The catch projection 113 is undercut, so that the catch bead 211 of the lower shell 21 latches under the catch projection 113.

In the region below the catch bead 211, the lower shell 21 is seated in a precisely fitted manner in the housing lower part 11, so that the lateral surfaces of the two press against one another over the largest possible area. Good heat transfer from the lower shell 21 to the housing lower part 11 is thus achieved. This lower part is preferably formed thin-walled, so that a heat transfer also takes place to the outer side of the housing part 11, where heat emission occurs via convection and/or radiant heat. Although the housing lower part 11 is manufactured from plastic, a non-negligible part of the heat generated by the lighting device can thus be dissipated.

Because of the different thermal expansion, the metallic lower shell 21 expands in relation to the housing lower part 11 upon heating, however. In order that this does not result in impermissible tensions in the materials, the catch bead 211 and the undercut part of the catch projection 113 are formed so that the catch bead 211 can yield outward in the catch position. For this purpose, for example, both the catch bead 211 and also the undercut of the catch projection 113 are rounded. There are no contact surfaces between the lower shell 21 and the housing lower part 11, the surface perpendiculars of which lie in the direction of the thermal expansion. In the event of expansion of the lower shell 21 in relation to the housing lower part 11, the lower shell 21 can yield upward in the catch position, without detaching from the latching.

Two opposing U-shaped guide webs 114, which protrude through passages 212 of the lower shell 21 into the interior of the base body 20, are provided in the lower part of the housing lower part 11. The connection module 40 having a printed circuit board (PCB) can be pushed into the guide webs 114.

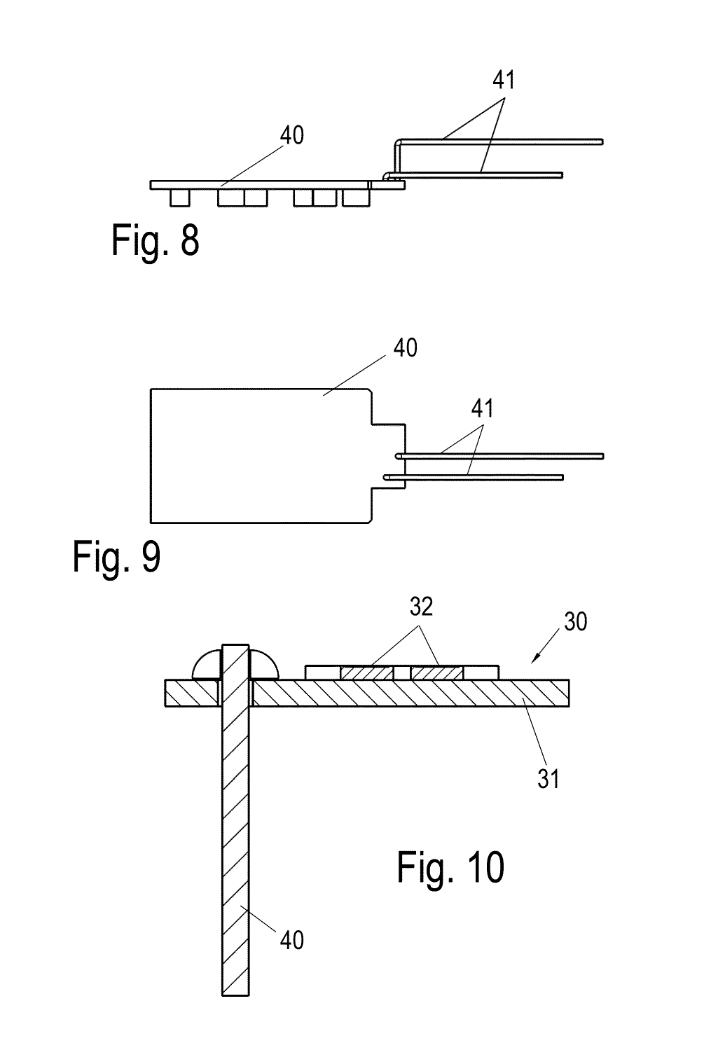

FIGS. 8 and 9 show, in a side view and a top view, the connection module 40. The connection wires 41 are fixed on the connection module 40, for example, by a soldered bond. According to the application, the connection wires 41 are embodied as rigid wires, wherein the diameter of the connection wires 41 can optionally be larger than is required for the electrical conductivity. The rigid embodiment of the connection wires 41 has the advantage that the connection wires 41 can be led without problems through openings in the lower shell 21 and the housing lower part 11 without problems during the automated installation of the connection module 40 and are therefore ready for contacting with the base 13. As shown in FIG. 8, the connection wires 41 can be led in different planes, so that they are spaced apart sufficiently from one another, even if the connection points of the connection wires 41 on the connection module 40 are closely adjacent. The connection wires 41 can be formed as insulated or also non-insulated wires. The rigidity or bending resistance also enables the alignment, fixing, bending, and/or cutting to size of these connection wires 41 in automated installation.

FIG. 10 shows an advantageous electrical connection between multiple printed circuit boards. In the present case, these are a printed circuit board of the connection module 40 and the printed circuit board 31 of the illuminant 30. It is to be noted that this type of connection of two printed circuit boards at an angle to one another can also be used in other areas of application. The electrical connection shown in FIG. 10 represents an alternative to the plug 42 shown in the preceding exemplary embodiments.

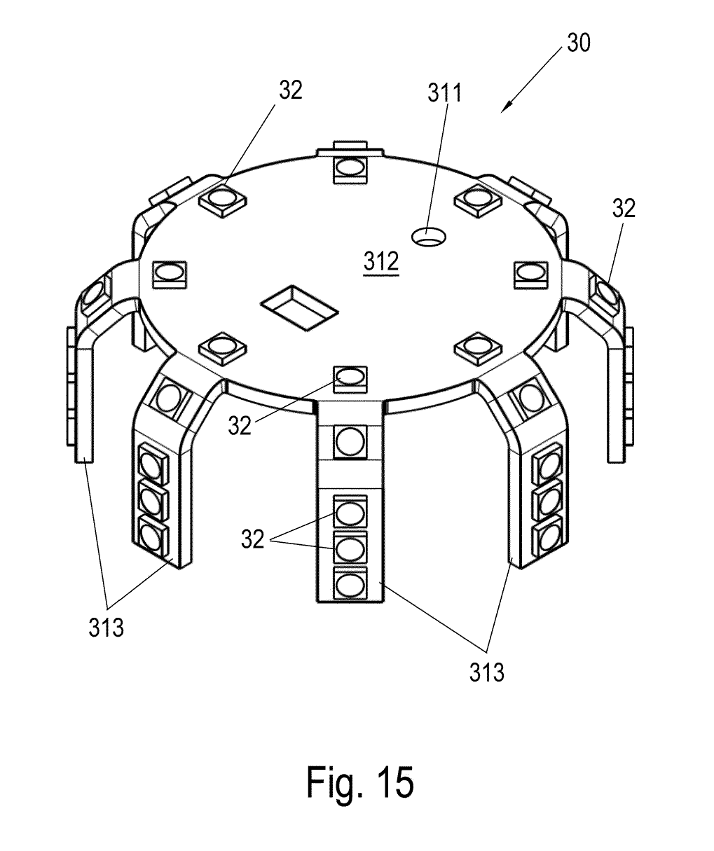

In the present case, a passage is provided in the printed circuit board 31, in which the printed circuit board (circuit board) of the connection module 40 is inserted with at least one part formed as a tab. The conductor tracks of the two printed circuit boards are subsequently soldered to one another after the joining, to establish the mechanical connection, on the one hand, and the electrical connection, on the other hand. In this case, a solder reservoir can already be applied on one of the printed circuit boards, for example, on the printed circuit board 31, which is melted by means of suitable soldering methods, for example, heating by laser, ultrasound, induction, or another soldering method, to produce the connection. The described method can be embodied, as shown in the present case, using two planar printed circuit boards, but also using three-dimensionally formed printed circuit boards (see also FIG. 15).

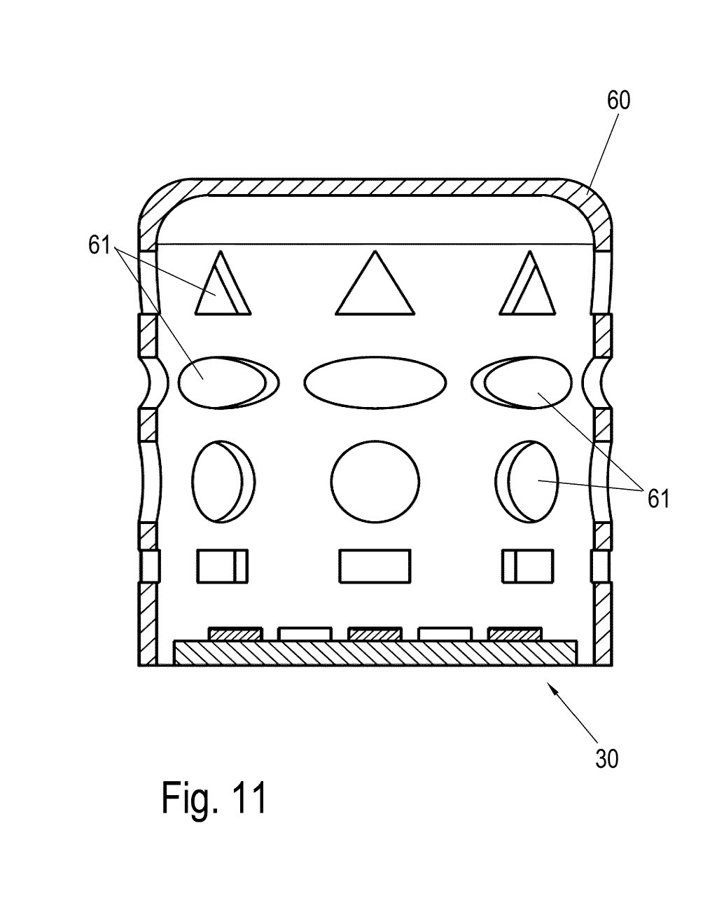

FIG. 11 shows a sectional illustration of a dome 60, which is provided with passages 61 in greatly varying geometry. This dome 60 can be put onto the upper shell 22 by a suitable method, for example, again by joining and/or latching, and encloses the illuminant 30. The dome 60 results in effective light distribution, which reflects the shape of the passages 61. Additionally or alternatively to the illustrated dome 60, mirrored metal parts can also be arranged around the illuminant 30, which result in a corresponding effective light distribution.

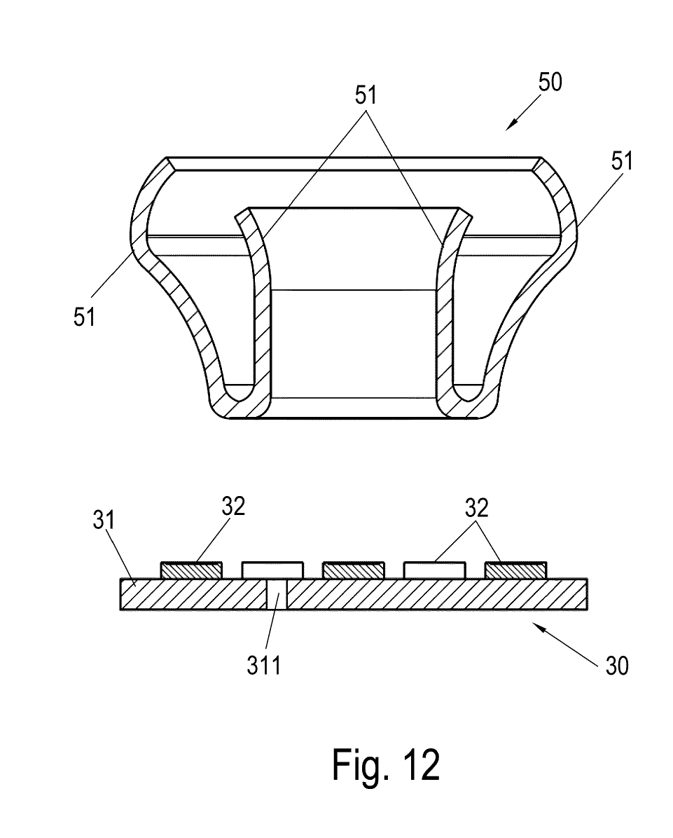

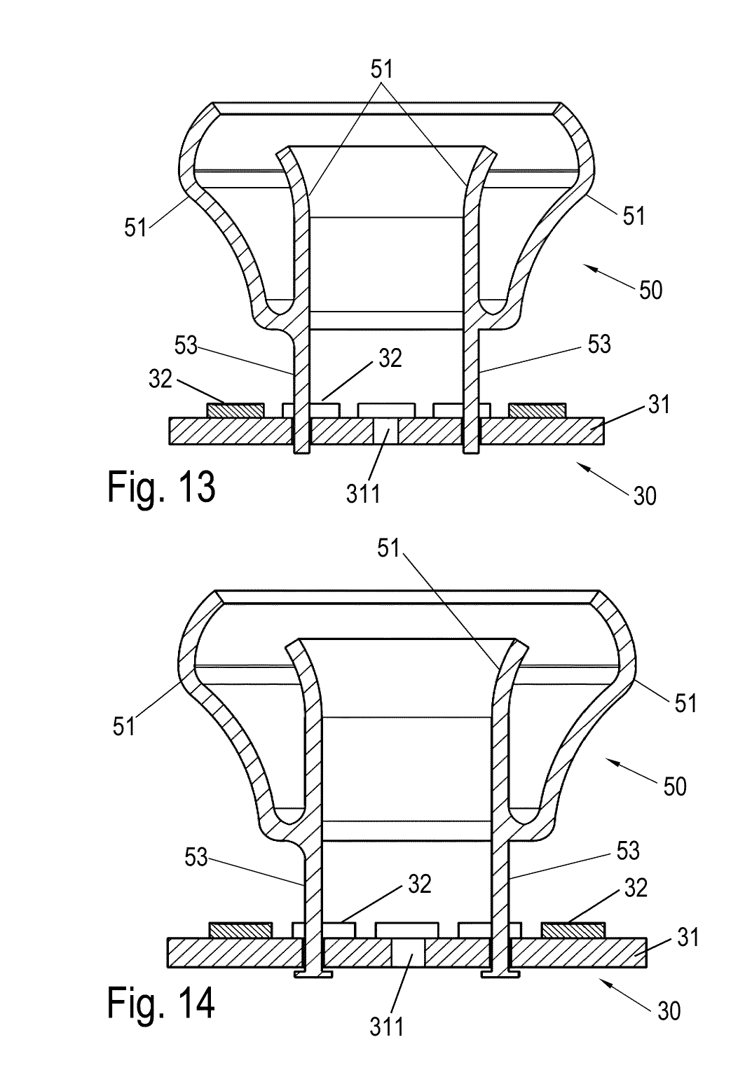

Various embodiments of an optical element 50, which is designed as a reflector here (cf. FIGS. 1 and 3), are shown in FIGS. 12 to 14, this element being used for the light distribution of the light emitted from the illuminant 30. It is additionally indicated in the exemplary embodiments of FIGS. 13 and 14 how such an optical element 50 can be fixed using appropriately designed legs 53 on the illuminant 30 and optionally additionally on the upper shell 22. It is possible in this case (cf. FIG. 14) to have the legs 53 also act as fastening clamps, via which fixing of the illuminant 30 on the base body 20 is performed. In this meaning, the optical element 50 can be used additionally and/or alternatively to the fixing of the illuminant 30 on the upper shell 22 in the manner of the fastening clamps 222 according to FIGS. 1 to 4. The flattened region at the lower end of the leg 53 can be formed during the insertion of the optical element 50 by a deformation process. By connecting the optical element 50 to the illuminant 30, effective heat transfer to the optical element 50 is also achieved, which can dissipate the absorbed heat as radiant heat and, in addition to the base body 20, represents an effective element for cooling the illuminant 30.

Inner and outer reflective surfaces 51 of the optical element 50 are advantageously formed rounded such that the optical element 50 does not display any sharp edges in the shadows. The optical element 50 is formed as a rotationally-symmetrical body, which has an open region in the interior. The light penetrating out through the internally open region and the light guided laterally past the optical element 50 are overlaid at long range to form a uniformly illuminated light field.

FIG. 15 shows a perspective illustration of a three-dimensionally formed illuminant 30. The printed circuit board (PCB) 31 of the illuminant 30 is not formed as planar (two-dimensional) in this case, but rather has a three-dimensional structure. In this case, LEDs 32 are arranged on surfaces which face in various directions. In this manner, a characteristic emitting on all sides is already achieved by the illuminant 30 itself, so that an additional optical element for light distribution can be omitted.

In this exemplary embodiment, production of the printed circuit board 31 of the illuminant 30 in a planar form is performed, wherein the printed circuit board 31 has a substantially cylindrical main region 312 having arms 313 protruding radially outward. LEDs 32 are arranged both in the main region 312 and also on the protruding arms 313. The passage 311 for fastening the illuminant 30 and also the further passage, through which the plug is plugged for contacting, are visible in the main region 312. The protruding arms 313 are subsequently bent over by deformation. In this case, a relatively large bending radius can be provided, so as not to damage the layer structure (aluminum carrier, insulation layer, conductor track). The forming can be performed either before installation of the LEDs 32 or after the installation thereof.

### LIST OF REFERENCE NUMERALS

10 housing
11 housing lower part
111 catch depression
112 fluting
113 catch projection
114 guide web
12 housing upper part
121 bearing edge
122 catch bead
123 ribs
13 base
20 base body
21 lower shell
211 catch bead
212 passage
22 upper shell
221 passage
222 fastening clamp
223 integral rivet
30 semiconductor illuminant
31 printed circuit board
311 main region
312 arm
32 light-emitting diode (LED)
40 connection module
41 connection wire
42 plug
50 optical element
51 reflective surface
52 lens
53 leg
60 dome
61 passage

1-13. (canceled)

14. A lighting device, comprising: at least one semiconductor illuminant; a housing made of plastic, in which the at least one semiconductor illuminant is accommodated, wherein
the lighting device has a metallic base body inside the housing, on which the semiconductor illuminant is fixed, and
the metallic base body has a surface which rests at least in portions internally against a wall of the housing.

15. The lighting device according to claim 14, wherein the base body is fixed in a latching or clamping manner in the housing.

16. The lighting device according to claim 15, wherein the base body has a catch bead, which latches under at least one catch projection arranged in the housing.

17. The lighting device according to claim 16, wherein the catch bead and an undercut part of the catch projection are formed so that the catch bead has a movement clearance in a catch position.

18. The lighting device according to claim 17, wherein the movement clearance extends in the direction of a wall of the base body.

19. The lighting device according to claim 14, wherein the metallic base body rests with at least 30% of its surface internally against the housing.

20. The lighting device according to claim 14, wherein the metallic base body rests with at least 50% of its surface internally against the housing.

21. The lighting device according to claim 14, wherein the base body has a cavity, in which a connection module is arranged.

22. The lighting device according to claim 14, wherein the base body is formed in two parts and is assembled from a lower shell and an upper shell.

23. The lighting device according to claim 14 wherein the semiconductor illuminant is fixed by a rivet on the base body.

24. The lighting device according to claim 23, wherein the rivet is formed integrally with the upper shell.

25. The lighting device according to claim 24, wherein the upper shell is originally formed with the rivet in a deep-drawing method.

26. The lighting device according to claim 22, wherein the lower shell and/or the upper shell are deep-drawn from aluminum.

27. The lighting device according to claim 23, wherein the lower shell and/or the upper shell are deep-drawn from aluminum.

28. The lighting device according to claim 24, wherein the lower shell and/or the upper shell are deep-drawn from aluminum.

29. The lighting device according to claim 25, wherein the lower shell and/or the upper shell are deep-drawn from aluminum.

30. The lighting device according to claim 14, wherein the lighting device is configured as a retrofit lighting device.
